(19) United States
(12) Patent Application Publication
(10) Pub. No.: US 2021/0051844 A1
(43) Pub. Date: Feb. 25, 2021

(54) SEED-POSITIONING DEVICE USED IN AGRICULTURAL PLANTING MACHINES

(71) Applicants: Pedro Luis Pereira Couto, Porto Alegre (BR); Thiago De Carvalho Ribeiro, Porto Alegre (BR)

(72) Inventors: Pedro Luis Pereira Couto, Porto Alegre (BR); Thiago De Carvalho Ribeiro, Porto Alegre (BR)

(21) Appl. No.: 17/042,270

(22) PCT Filed: Mar. 28, 2018
(86) PCT No.: PCT/BR2018/050084

§ 371 Date: Sep. 28, 2020

(51) Int. Cl. A01C 7/12; A01C 7/20; A01C 7/08; F16H 37/06

(52) U.S. Cl. CPC A01C 7/128; A01C 7/206; F16H 2702/02; F16H 37/065; A01C 7/082

(57) ABSTRACT

The seeding positioner device applied to agricultural planters comprising a structure consisted of a rotating seed pusher that directs the seeds to a labyrinth (14) moving in a opposite direction, allowing to control the seed release as the speed the assembly rotates, so that the discharge spacing will be commanded by a gears-driven compartment (22) which directs the seeds to a discharge tube (23), wherein the pneumatic system generates positive air pressure. Thus, the compressed air will push the seed against the soil in order to maintain the perfect line positioning and increasing the planting speed. The seeding positioner device can be driven by an electric motor, a pneumatic motor, a hydraulic motor, a cardan shaft, a pitch chain, or a twisting cable, according to the planter type. In addition, the device constructional shape prevents the seeds from being damaged and loses germination capacity when passing through the mechanism, allowing the equipment to be applied and adapted to work with any seed type.

### FIELD OF THE INVENTION

The present invention describes a seeding positioner device applied to agricultural planters. More specifically, it comprises a structure consisted of a rotating seed pusher directing the seeds to a labyrinth moving in an opposite direction, allowing to control the seeds release as the assembly speed rotates, so that the discharge spacing will be commanded by a gears-driven compartment directing the seeds to a discharge tube, wherein a pneumatic system generates positive air pressure. Thus, the compressed air will push the seed against the soil in order to maintain the perfect line positioning and increasing the planting speed.

The seeding positioner device may be driven by an electric motor, a pneumatic motor, a hydraulic motor, a cardan shaft, a pitch chain, or twisting cable, according to the planter type. In addition, the device constructional shape prevents the seeds from being damaged and loses the germination capacity when passing through the mechanism, allowing the equipment being applied and adapted to work with any type of seed.

### BACKGROUND OF THE INVENTION

Crop productivity is directly associated with seeding quality, the process of which should be performed within high standards of quality and accuracy to ensure an adequate seeding density and consequently success in crop deployment.

At the time of seeding, it is recommended the factors such as plant population, germination capacity and seed purity, the sliding index of the seeder drive wheel, the filling percentage of the dispenser mechanism and the field survival index are considered.

However, little or no attention has been given to the seed dispenser mechanism as a damaging agent even though it is known that, when it passes through this mechanism, the seeds suffer pressures becoming susceptible to mechanical damages, which reduce its germinative capacity and strength.

Mechanical damage can either cause the seed death (in case of a severe impact) or cause it to crack the coat, facilitating the access of pathogenic microorganisms to its inner part.

Among the most important distinctives of a seeder-fertilizer spreader machine is its ability to provide low damage index to seeds during seeding. Thus, its dispenser mechanism must be suitable for the species and variety to be seeded to prevent the seeds from being damaged and losing their germinative capacity.

In addition, the work speed in the seeding operation is a factor that can influence the regularity of seed distribution, and therefore the seed dispenser system must be able to supply such disagreement, maintaining the high quality and accuracy of operation. However, the dispenser mechanisms show several restrictions regarding the operation speed, limiting the planting speed and, due to the width of each line, making it impossible to reduce the spacing between planting lines, causing waste of fertile soil, directly reflecting the planting productivity.

Currently, the market provides farmers with seeders equipped with the following seed dosing dispenser mechanisms: perforated disc (horizontal, vertical, or tilted), grooved rotor (parallel or helical), pneumatic (vacuum or blow), pressing fingers and dispenser cup. Although each of the systems provided is known, the literature shows varied, sometimes conflicting data, suggesting the need for further studies on the subject matter.

On the other hand, seeding machines are classified into two main types according to the seed distribution way, which can be accuracy for seeding bigwig grains such as soybean and corn, or continuous flow for seeding small seeds such as wheat, sorghum, and millet.

The great difference between the two types of seeding machines is that the accuracy one distributes the seeds at regular intervals between them and with greater spacing between lines, using horizontal disc- or vacuum-type dispenser devices. Thus, it is worth detailing the operation of these two models due to the application being more widespread in the market:

The horizontal dispenser disc has openings or cells and rotates at the bottom of the seed tank. As the disc rotates, the seeds fall into the disc cells. If the disc cells are of appropriate size, only one seed will fall in each cell, in addition, these devices are spring-loaded to prevent more than one seed from falling into the discharge tube. This system provides a very even seed distribution, as long as the seeding is well calibrated, but it is more likely to cause mechanical damage and requires rigorous seed classification. As it is a simple and widespread technology, equipment is cheaper to acquire. On the other hand, this system has a very low planting speed, having many failures in the delivery of seeds to the soil because the vibration caused by soil irregularities makes the seeds to move from the cells, which is a limitation in the planting speed.

In the vacuum dispenser disc, the seeds are kept trapped in the holes because of the atmospheric pressure of the air due to the pressure on the opposite side of the seeds, which is reduced by a vacuum created by a fan, being equipped with an eliminator device which is used to remove seeds in excess that are adhered to the holes. These systems, properly calibrated, provide precision planting but do not reduce the generation of mechanical damage and, because they use more sophisticated technology, they are more expensive equipment. In addition, this equipment features several components increasing the likelihood of failure and double seed generation. This system allows greater planting speed because there is no displacement of the seeds from the cells, but the limitation of planting speed remains due to mechanical limitations, since the seed accommodation in the cells takes an uncontrollable time externally.

Thus, after analyzing the seed dispenser mechanisms described in the market, we found this equipment has several inconveniences to farmers due to the high incidence of mechanical damage to the seeds, excessive amount of components making the equipment very large and heavy, generation of double seeds, no precision in delivering the seed to the soil, as all these systems make the seed reach the soil only by the gravity force, causing the seeds may “roll” at the soil, and modify the longitudinal spacing and restriction of the operating speed.

It is important to note the seed developers always insist the perfect spacing between seeds is essential for productivity, as productivity is synonymous with leaf sunstroke and if the seeds are not in the correct spacing indicated by the cultivar's creator one of two things occurs: either the seeds are very close, not allowing a leaf makes the most of the sunstroke or the seeds are too widely spaced, wasting the soil area.

Therefore, the present applicant has developed a dispenser mechanism and seed positioner having its own and innovative embodiment resulting in improvement against the equipment described in the prior art.

Thus, it is the object of the present invention a seeding positioner device applied to agricultural planters comprising a structure consisted of a rotating seed pusher directing the seeds to a labyrinth that moves in the opposite direction, allowing to control the seed release according to the speed the assembly rotates in such a way the discharge spacing will be controlled by a gears-driven compartment directing the seeds to a discharge tube, wherein a pneumatic system generates positive air pressure.

Therefore, the compressed air will push the seed against the soil in order to maintain the perfect line positioning and increasing the planting speed. In addition, the device can be applied and adapted to work with any seed type due to its constructional shape prevents seeds from being damaged when passing through the mechanism, increasing the planting speed in order to avoid the incidence of double seeds and mechanical damage to the seeds.

### SUMMARY OF THE INVENTION

It is distinctive of the invention privilege a seeding positioner device applied to agricultural planters providing a casing equipped in its front portion with a circular opening which receives a structure for selecting and directing the seeds.

It is distinctive of the invention privilege a seeding positioner device applied to agricultural planters providing a conical structure for selecting and directing the seeds equipped with sinuous grooves directing the seeds to positioning holes.

It is distinctive of the invention privilege a seeding positioner device applied to agricultural planters providing a spiral structure called labyrinth or snail, provided with a groove that is arranged next to the structure of selecting and directing the seeds.

It is distinctive of the invention privilege a seeding positioner device applied to agricultural planters providing a gear equipped with a bass-relief on its faces.

It is distinctive of the invention privilege a seeding positioner device applied to agricultural planters providing a gear equipped with a bass-relief that presents on one of its faces the arrangement of an assembly of drive gears.

It is distinctive of the invention privilege a seeding positioner device applied to agricultural planters providing a gear equipped with a bass-relief that receives the structure of seed selection and direction.

It is distinctive of the invention privilege a seeding positioner device applied to agricultural planters providing a compartment driven by a system of gears and cams.

It is distinctive of the invention privilege a seeding positioner device applied to agricultural planters providing the seed delivery to the soil through a pressurized system pneumatically driven by an air pump that is part of the assembly.

It is distinctive of the invention privilege a seeding positioner device applied to agricultural planters providing seed selection and directing structure that rotates to one side, forcing the seeds to enter a spiral structure called labyrinth or snail that rotates in the opposite direction.

It is distinctive of the invention privilege a seeding positioner device applied to agricultural planters providing a system of planetary gears, which perform the rotations of the labyrinth and the seed pusher in a synchronized manner.

It is distinctive of the invention privilege a seeding positioner device applied to agricultural planters providing an automatic adjustment system by means of a friction system to eliminate spacings between the seeds within the labyrinth.

It is distinctive of the invention privilege a seeding positioner device applied to agricultural planters optionally providing the replacement of the friction system by the use of an electric motor.

It is distinctive of the invention privilege a seeding positioner device applied to agricultural planters providing a seed release system that depends on the speed at which the assembly rotates.

It is distinctive of the invention privilege a seeding positioner device applied to agricultural planters providing a compartment which controls seed discharge spacing.

It is distinctive of the invention privilege a seeding positioner device applied to agricultural planters providing a pneumatic system through compressed air which pushes the seed against the soil, increasing the planting speed.

It is distinctive of the invention privilege a seeding positioner device applied to agricultural planters providing the possibility of driving the equipment through an electric motor, a pneumatic motor, a hydraulic motor, a cardan shaft, a pitch chain, or a twisting cable.

It is distinctive of the invention privilege a seeding positioner device applied to agricultural planters providing equipment that can be adapted to any type and model of planter.

It is distinctive of the invention privilege a seeding positioner device applied to agricultural planters providing equipment that can be used to dispense any type of seed.

It is distinctive of the invention privilege a seeding positioner device applied to agricultural planters providing equipment that prevents seeds from being damaged and loses germinative capacity when passing through the mechanism due to the device's constructional shape.

### BRIEF DESCRIPTION OF THE FIGURES

FIG. 1 shows the perspective view of the seed positioning equipment.

FIG. 2 shows the side view of the seed positioning equipment.

FIG. 3 shows the top view of the seed positioning equipment.

FIG. 4 shows the bottom view of the seed positioning equipment.

FIG. 5 shows the rear perspective view of the seed positioning equipment.

FIG. 6 shows the perspective view of the first structure of the seed positioning equipment.

FIG. 7 shows the front view of the first structure of the seed positioning equipment.

FIG. 8 shows the rear perspective view of the first structure of the seed positioning equipment.

FIG. 9 shows the perspective view of the geared plate detailing its embodiment.

FIG. 10 shows the rear perspective view of the geared plate detailing its embodiment.

FIG. 11 shows the perspective view of the seed selector cone detailing its embodiment.

FIG. 12 shows the front view of the seed selector cone detailing its embodiment.

FIG. 13 shows the top view of the seed selector cone detailing its embodiment.

FIG. 14 shows the rear perspective view of the seed selector cone detailing its embodiment.

FIG. 15 shows the front view of the labyrinth detailing its embodiment.

FIG. 16 shows the side view of the labyrinth detailing its embodiment.

FIG. 17 shows the rear perspective view of the labyrinth detailing its embodiment.

FIG. 18 shows the expanded perspective view of the assembly provided with selector cone, labyrinth, and geared plate.

FIG. 19 shows the rear expanded perspective view of the assembly provided with selector cone, labyrinth, and geared plate.

FIG. 20 shows the rear perspective view of the assembly provided with selector cone, labyrinth, and geared plate, detailing the solar gear and the planetary gears.

FIG. 21 shows the side view of the assembly provided with selector cone, labyrinth, and geared plate assembled.

FIG. 22 shows the rear view of the assembly provided with selector cone, labyrinth, and geared plate, detailing the solar gear and the planetary gears.

FIG. 23 shows the perspective view of the seed positioning equipment, detailing the set provided with selector cone, labyrinth, and geared plate, and the clutch system.

FIG. 24 shows the perspective view of the second structure of the seed positioning equipment, detailing its embodiment.

FIG. 25 shows the front view of the second structure of the seed positioning equipment, detailing its embodiment.

FIG. 26 shows the rear perspective view of the second structure of the seed positioning equipment, detailing its embodiment.

FIG. 27 shows the perspective view da compartment, detailing its embodiment.

FIG. 28 shows the rear perspective view da compartment, detailing its embodiment.

FIG. 29 shows the perspective view of the discharge tube, detailing its embodiment.

FIG. 30 shows the rear perspective view of the discharge tube, detailing its embodiment.

FIG. 31 shows the rear perspective view of the seed positioning equipment, detailing the assembly of gears promoting the drive of the system.

FIG. 32 shows the rear view of the seed positioning equipment, detailing the assembly of gear promoting the drive of the system.

FIG. 33 shows the rear perspective view of the seed positioning equipment, detailing the assembly of gear promoting the drive of the system, with no main gear.

FIG. 34 shows the perspective view of the seed positioning equipment, detailing the assembly of gear promoting the drive of the system with the pressurizer system.

FIG. 35 shows the perspective view of the pressurizer system, detailing its embodiment.

FIG. 36 shows the rear perspective view of the pressurizer system, detailing its embodiment.

FIG. 37 shows the cross-section side view of the pressurizer system, detailing its embodiment.

FIG. 38 shows the perspective view of the fourth structure do equipment, detailing its embodiment.

FIG. 39 shows the cross-section side view of the seed positioning equipment, detailing its embodiment and positionings of the components.

FIG. 40 shows the cross-section side view of the seed positioning equipment, detailing the seed pass system.

FIG. 41 shows the expanded perspective view of the seed positioning equipment, detailing the arrangement of the components.

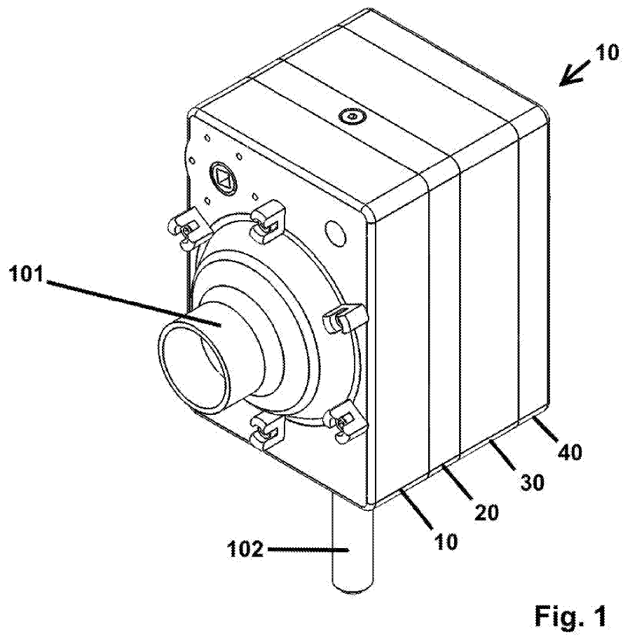

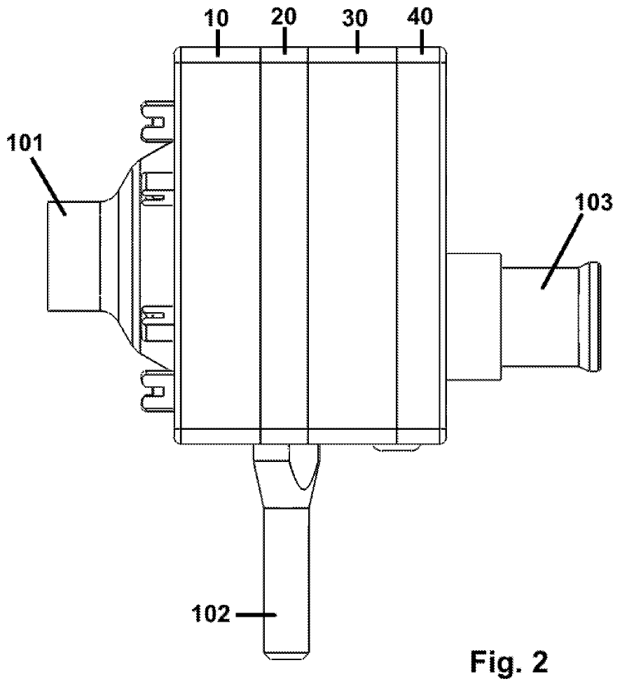

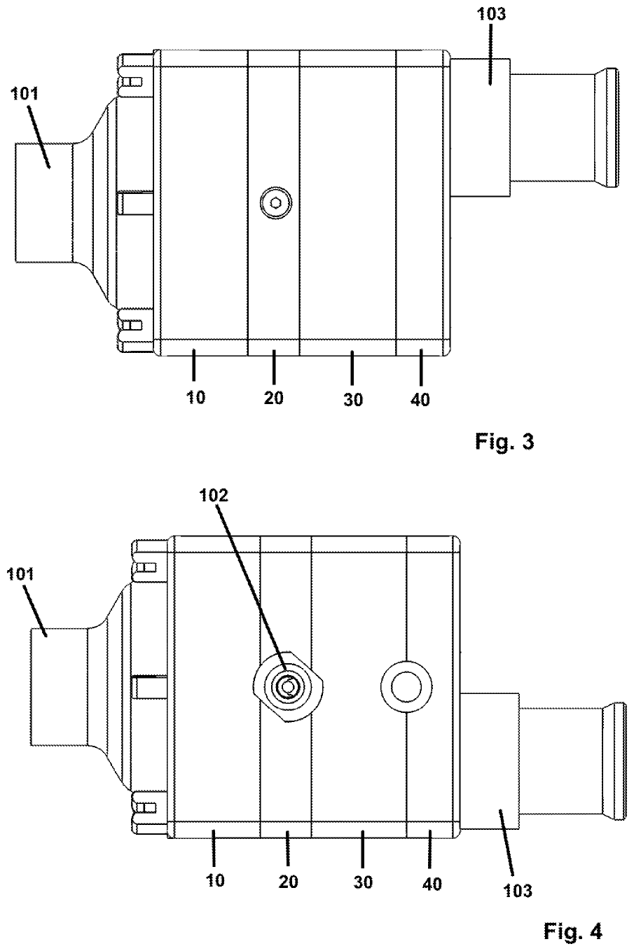

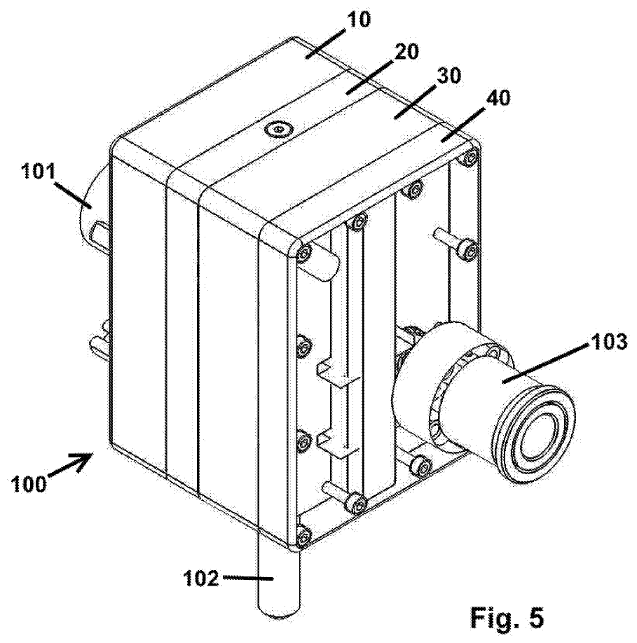

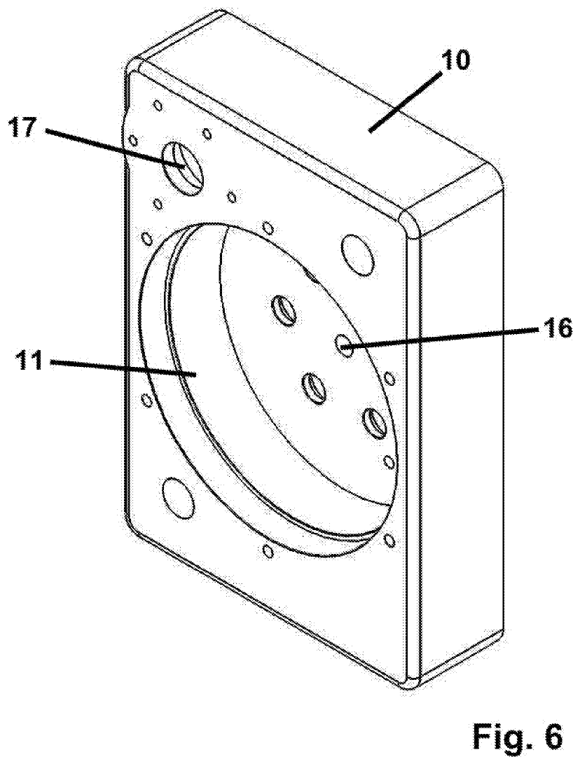

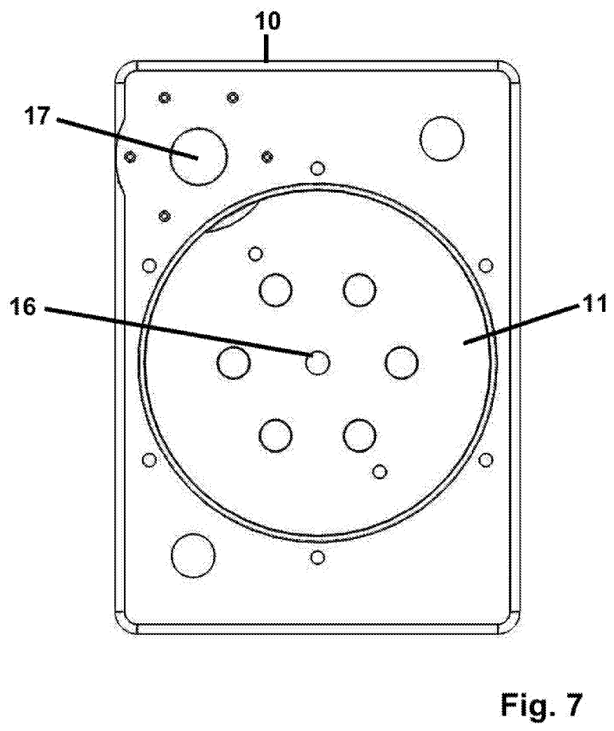

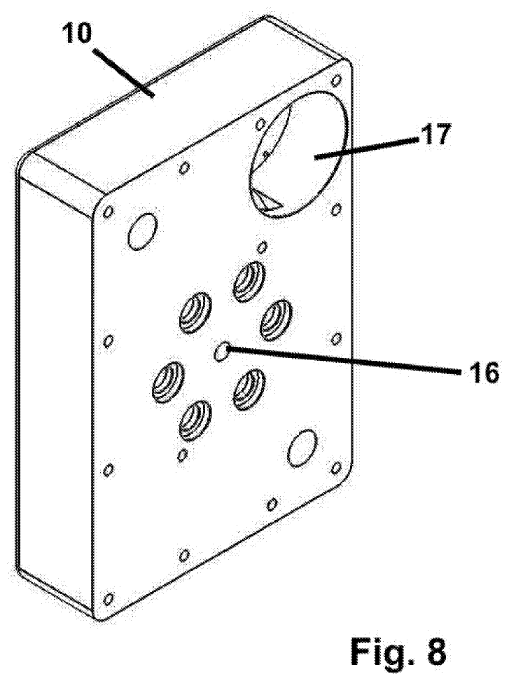

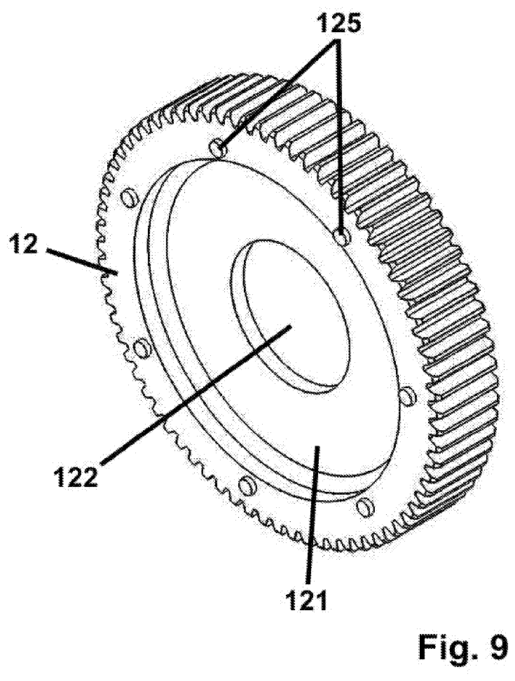

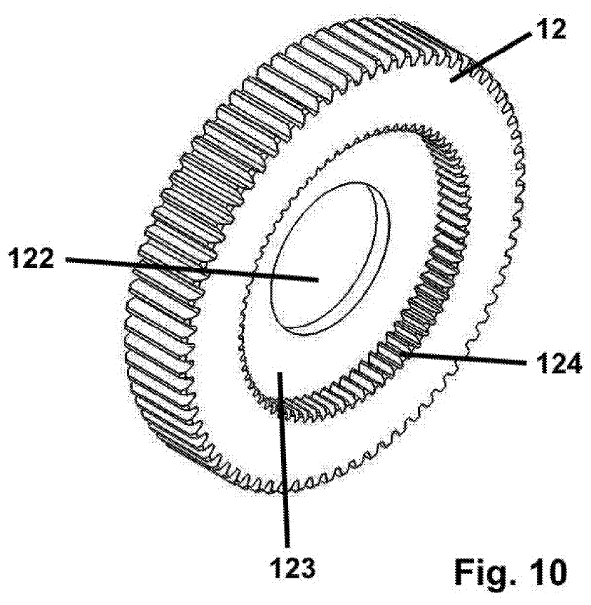

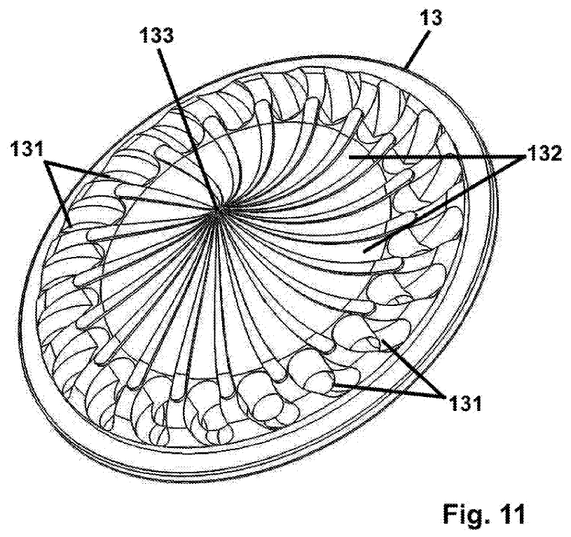

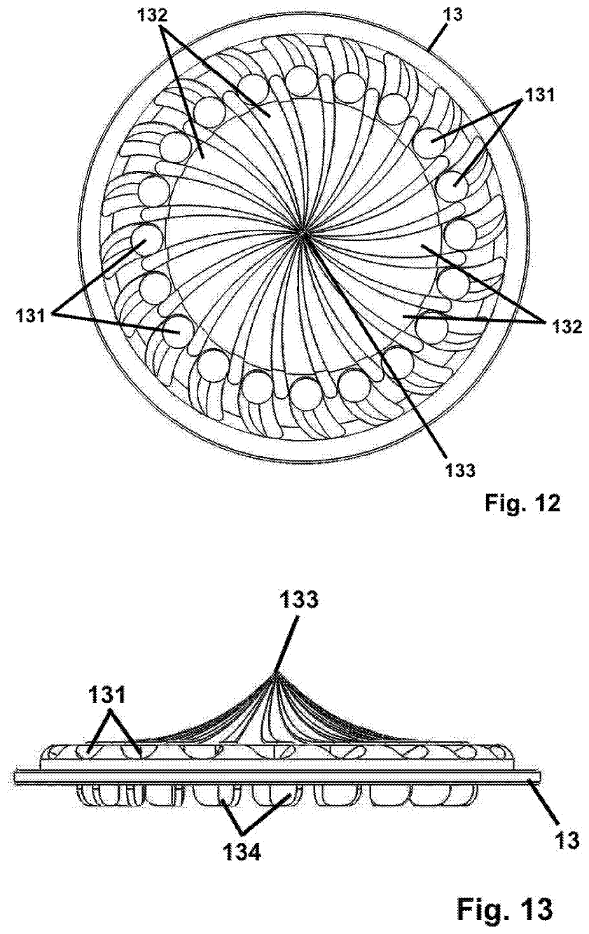

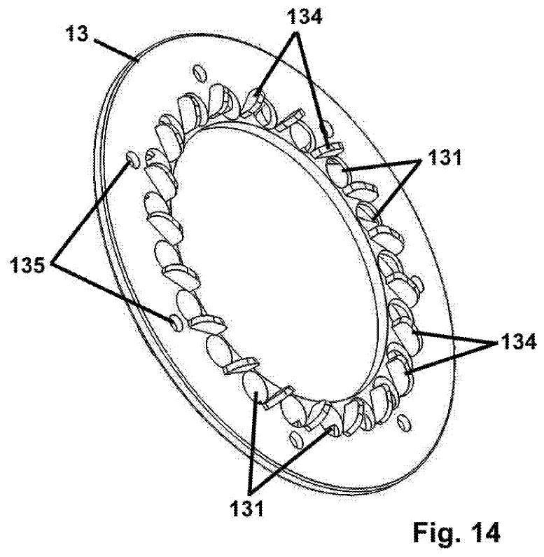

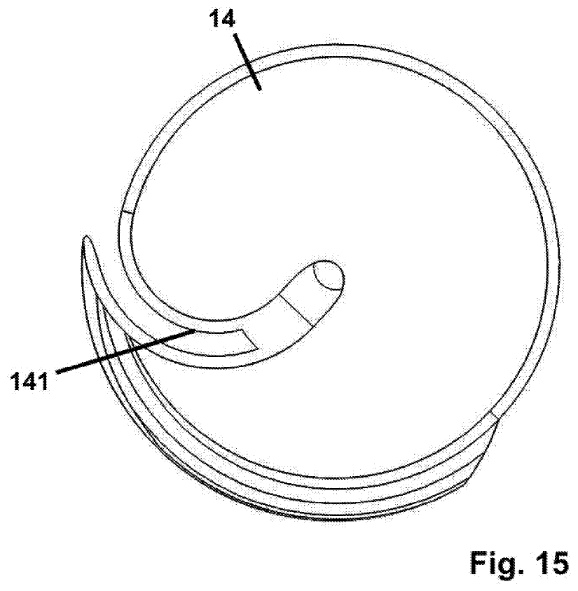

### DETAILED DESCRIPTION OF THE INVENTION

The seeding positioner device applied to agricultural planters, object of the present invention, comprises a structure (100) provided with a scutcheon (101) for fixing the seed tube, a discharge nozzle (102) close to the soil and an equipment traction coupling system (103), the structure (100) being consists of a structure assembly (10), (20), (30) and (40) that allows the positioning of its components, resulting in a compact equipment that increases the planting speed and enables to reduce the distance between lines.

The structure (10), arranged in the front portion of the structure (100), is provided with circular bass-relief (11) receiving the arrangement of a geared plate (12), a seed selection cone (13), a labyrinth or snail (14) and an assembly of planetary gears (15). The structure (10) has a central point (16), arranged with the bass-relief (11), which directs the seed to the structure provided with the seed discharge spacing.

The geared plate (12) has a bass-relief (121) provided with a through hole (122) on its front portion and a bass-relief (123) provided with teeth (124) on its back portion. In addition, the geared plate (12) has protrusions (125) arranged on the front face allowing the fitting and fixation with the seed cone (13).

The seed selection cone (13) has an assembly of holes (131) aligned with grooves (132) from its central portion, so that the cone has a ‘Chinese hat’ shape with a high relief (133) in its central portion. This shape allows seeds to be selected and positioned over the assembly of holes (131), with the high relief (133) being aligned with the escutcheon (101). In addition, the cone (13) has fins (134) arranged in the lower portion next to the holes (131) in order to facilitate the direction of the seeds. The cone (13) is attached to the geared plate (12) through spacings (135) that receive the protrusions (125) of the gear (12) in order to follow its rotational movement, allowing the selector (13) to supportive rotate with the annular gear (12).

The spiral structure (14), called labyrinth or snail, is provided with a groove (141) having a winding shape from the edge to the central portion of the structure (14) in order to allow the seed to be arranged in the cone (13) is captured by the labyrinth (14) and positioned next to the central point (16) of the structure (10).

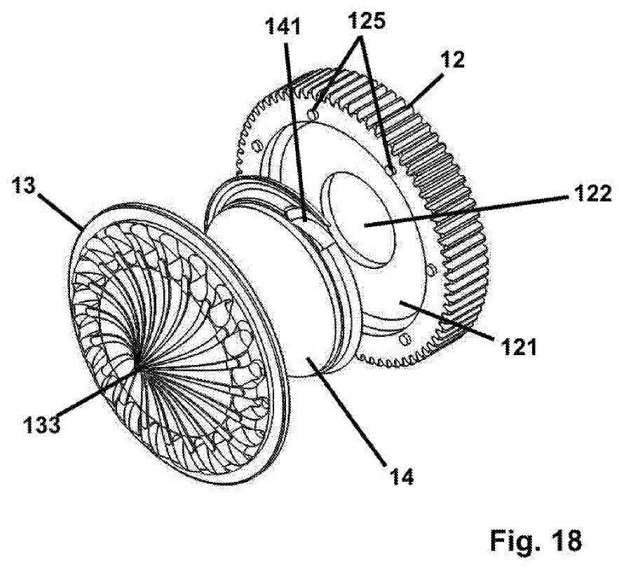

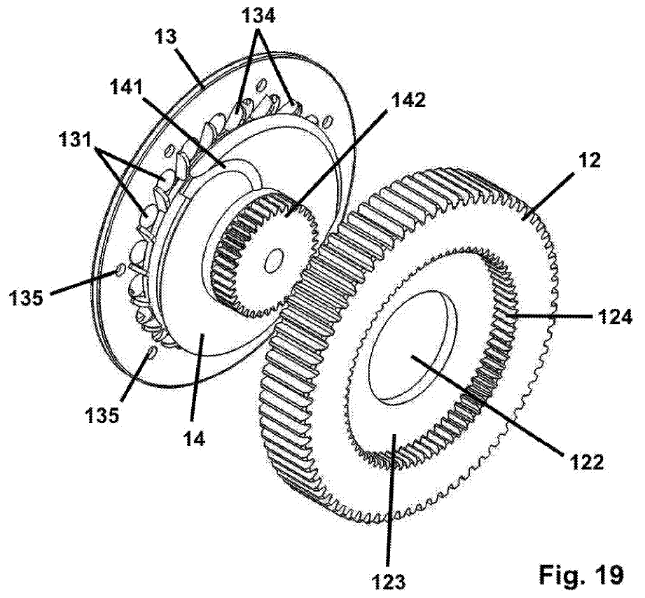

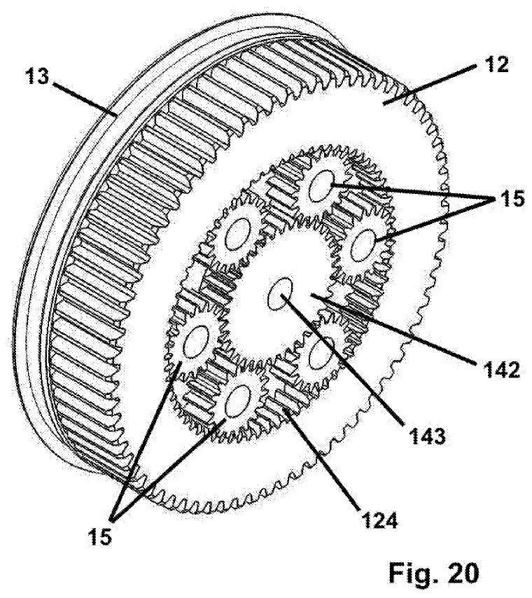

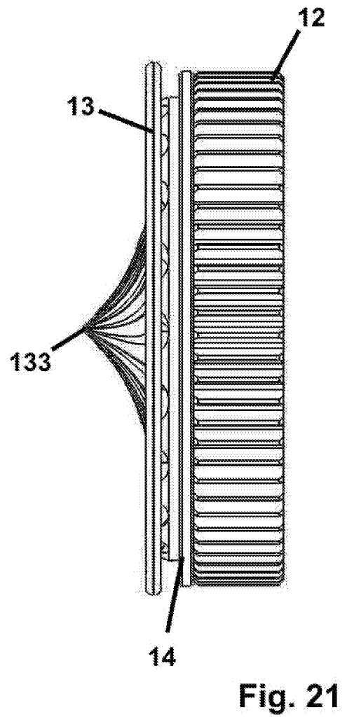

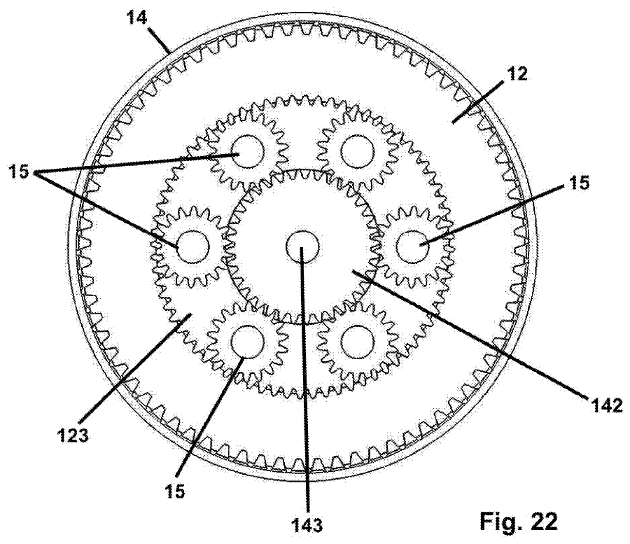

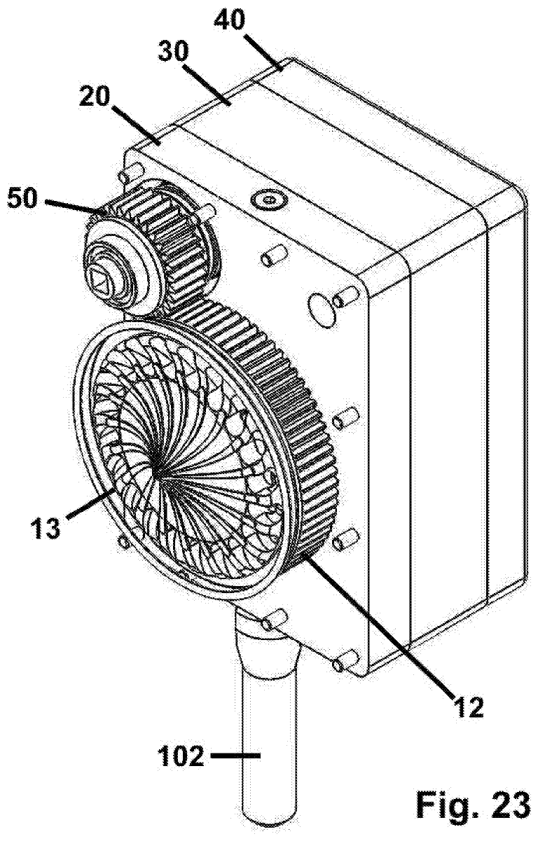

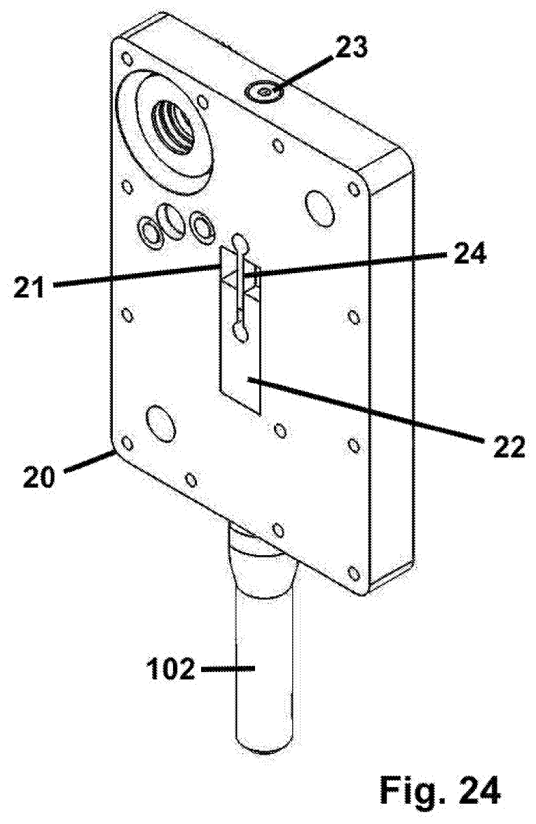

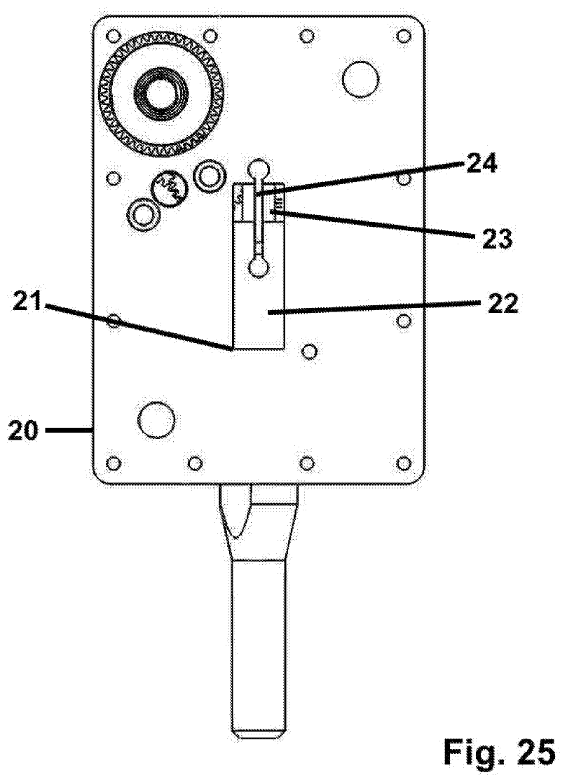

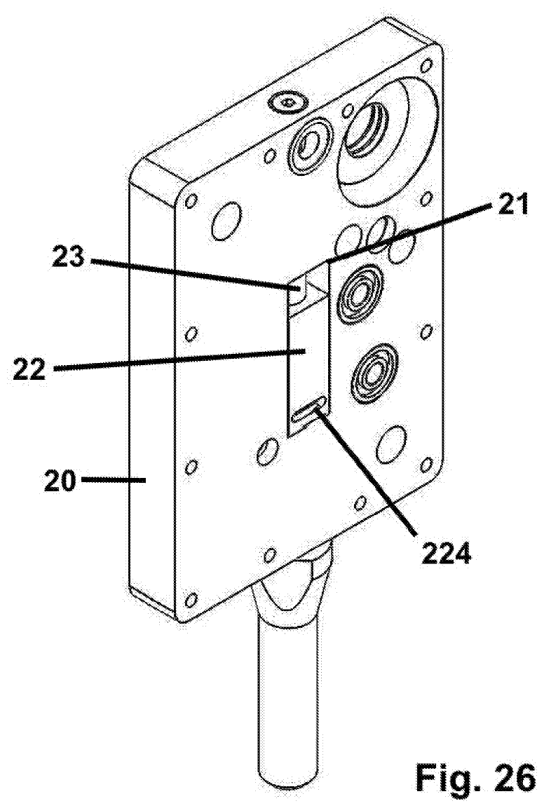

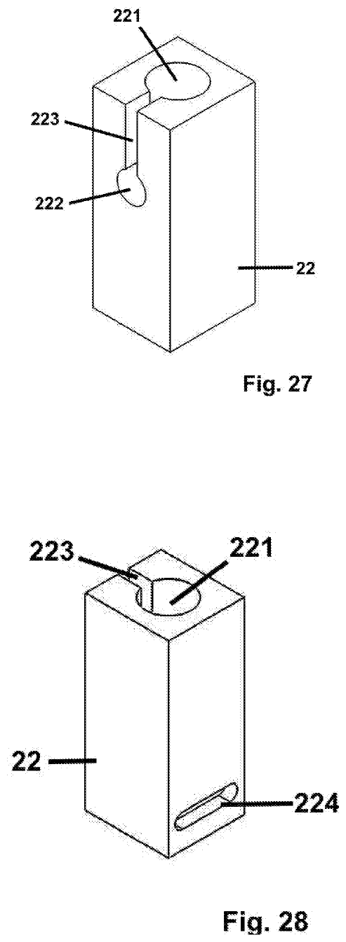

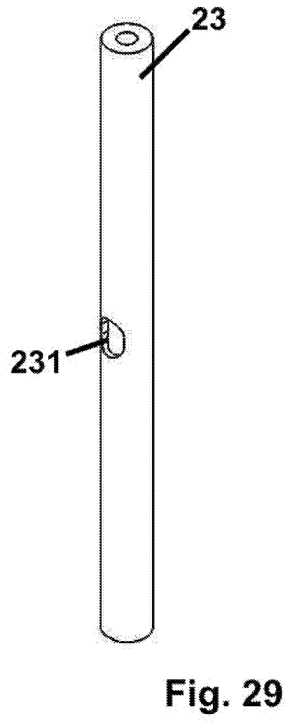

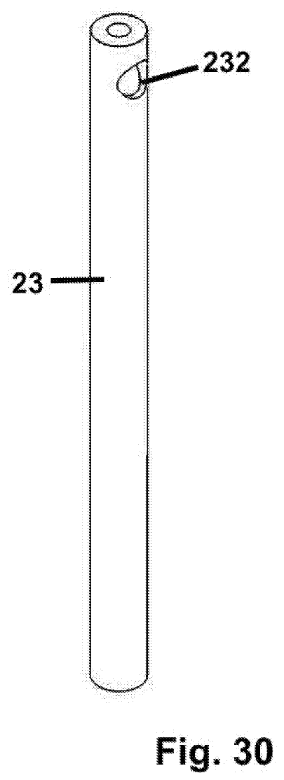

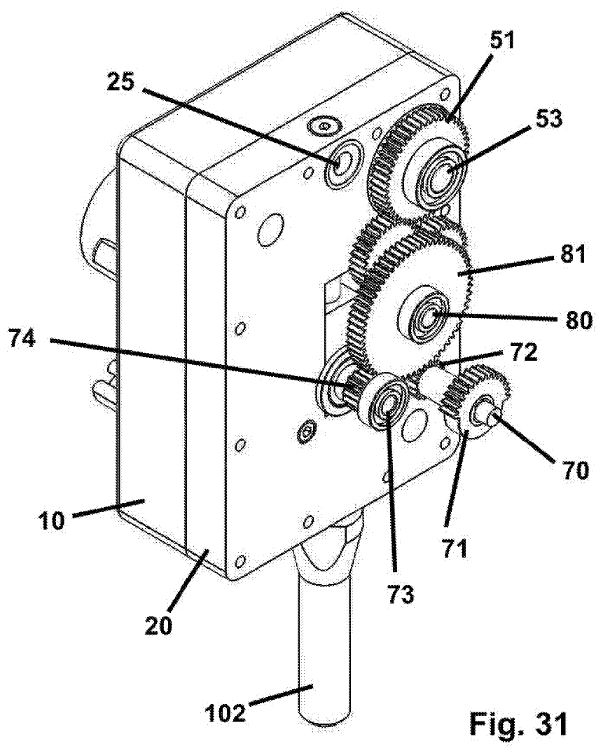

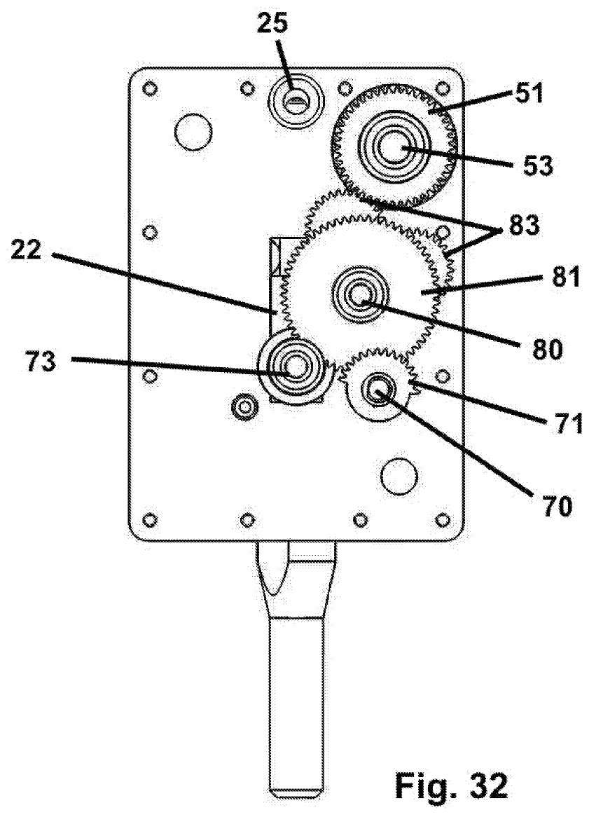

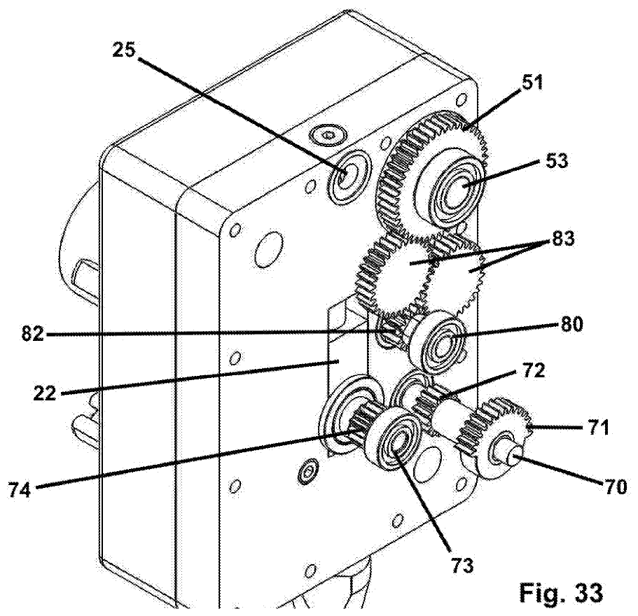

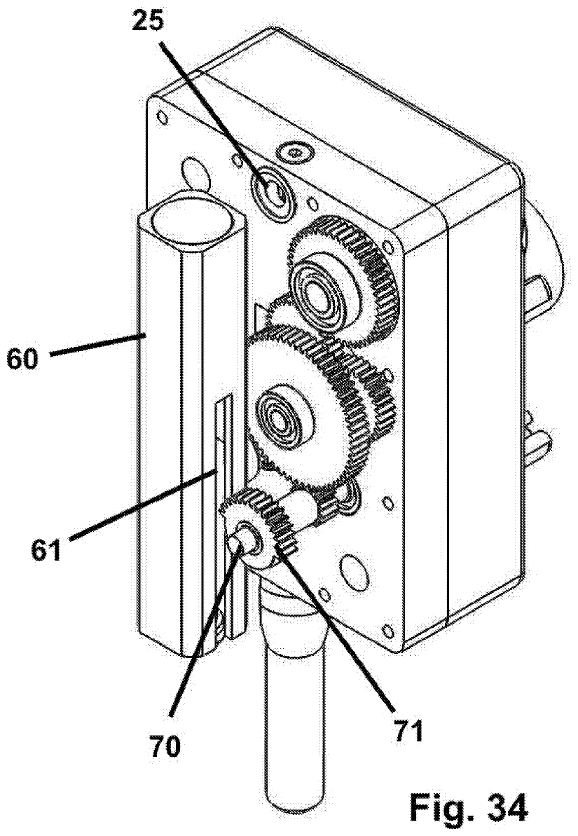

The labyrinth (14) is provided with a gear (142) equipped with hole (143) connected to an assembly of planetary gears (15) attached to the structure (10). The labyrinth (14) is arranged next to the bass-relief (121) so that the gear (142) is positioned next to the hole (122) of the geared plate (12), as described in FIGS. 18 and 19.

This embodiment allows the labyrinth (14) to perform the rotational movement in opposite direction to the plate (12) in order to force the seeds into the groove (141), directing the seeds through the hole (143) to the central point (16) which positions the seed next to the structure (20) provided with the discharge spacing.

The geared plate (12) allows the movement of the cone (13) and labyrinth (14) to be performed in the opposite direction, allowing the seed capture and directing to the discharge spacing system.

The structure (10) also has a circular spacing (17) arranged close to the upper portion that receives the assembly of gear (50) moving with to the geared plate (12) in order to compensate for the possible lack of seed with one or more holes (131) of the cone (13).

The annular gear or geared plate (12) has the external gearing and internal gearing from the movement of the assembly (12), (13) and (14).

External gearing is performed by connecting the clutch gear (50) bringing the external force to the annular gear (12), making the gear (12) rotates in one direction.

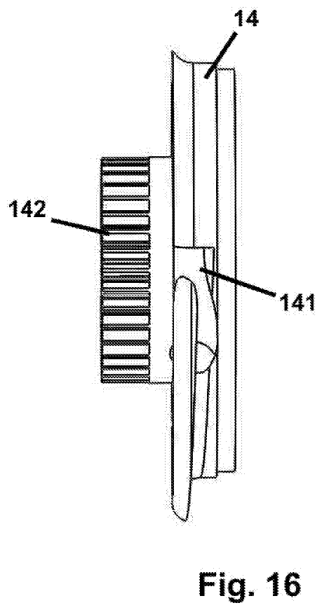

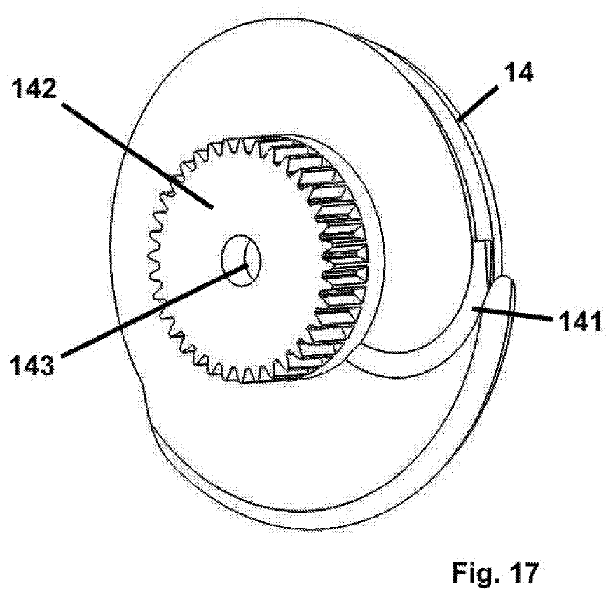

Internal gearing moves planetary gears (15) that brings movement to the solar gear (142) of the labyrinth (14) in the opposite direction of the annular gear (12), said solar gear (142) which is rigidly attached to the labyrinth (14) as shown in FIGS. 16 and 17.

Thus, it makes it possible to rotate the seed selection cone (13) and labyrinth (14) in opposite directions. This pair of pieces working in assembly has the function of conveying the seeds neatly into the groove (141) of the labyrinth (14), so that the seeds fall through the central hole (143) into the compartment (22) that will define the release of seeds/minute to the discharge tube (102).

This combination of contrary rotations greatly increases the seed feeding speed, breaking the situation of the current seed dispensers which have planting speed limitation due to seed delivery speed limitation.

The seeds selected by structure (10) are directed to a structure (20) having a central opening (21) provided with a rectangular structure (22), called a compartment, which has a discharge tube (23) connected to nozzle (102) of the equipment (100).

The rectangular-shaped compartment (22) has a transversal hole (221) that receives the discharge tube (23) and a longitudinal hole (222), the hole (222) being connected to the upper portion of the hole (221) through a groove (223). An oblong hole (224) is arranged in the back portion of the compartment (22).

The cylindrical-shaped tube (23) is provided with a hole (231) allowing the alignment with the hole (222) from the compartment (22) and hole (232) enabling the air to enter, allowing at each vertical movement of the compartment (22) the seed is directed to the hole (231) of the tube (23), and consequently directed to the nozzle (102) of the equipment.

The central opening (21) has a structure (24) which fits the groove (223) of the compartment (22) in order to assist in the vertical movement and in the seed direction to the hole (231) of the tube (23).

The compartment (22) is aligned with the hole (143) of the labyrinth (14) so that the seed is directed into the compartment (22), so the compartment is vertically moved until the seed is directed to the hole (231) of the tube (23) through the aid of structure (24).

The structure (20) has in its back portion a spacing (25) aligned to the hole (232) of the tube (23) that allows the air to be directed into the tube.

In the back portion of the structure (20) and next to the structure (30) the entire kinetic distribution of the equipment is concentrated, providing power for the assembly (12), (13) and (14) of the body (10) for the pressurizer system (60) and the compartment drive system (22) provided with the tube (23).

The drive system of gear assembly is performed by means of motor energy (not shown) which transmits the rotational movement to the shaft (70) provided with a semi-gear (71) driving the pressurizer system (60) and an intermediate gear (72) moving the shaft (80) provided with a main gear (81) and an intermediate gear (82).

The gear (81) transmits its rotation to the shaft (73) through the movement of an intermediate gear (74), said shaft (73) having an cam pin at its end that fits into the compartment (22) through the oblong hole (224), causing the compartment (22) to have a straight and alternative movement (up and down).

The intermediate gear (82) conveys the movement to a pair of intermediate gears (83) which convey the energy to the gear (51) of the clutch system (50), moving the geared plate (12) and the cone system (13) and the labyrinth (14).

The clutch system (50) aims to avoid grain breakage or locking accident, as the energy generated by the gear assembly reaches the geared plate (12) after passing through an adjustable torque friction system. The clutch (50) ensures that, above a certain torque, the gear (52) arranged next to the geared plate (12) slides over the shaft (53), disconnecting the power source from the consuming assembly.

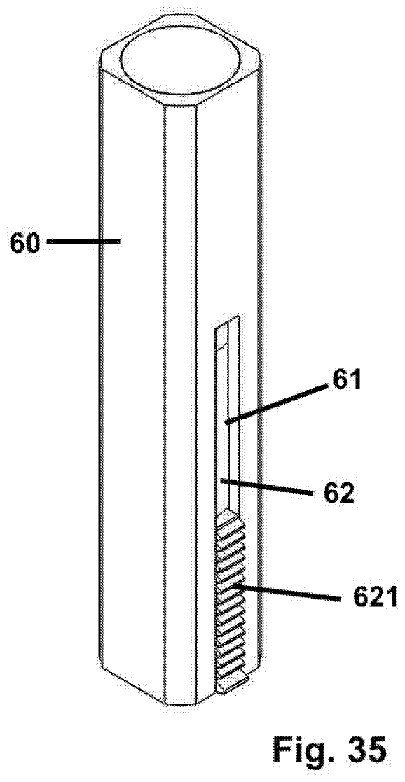

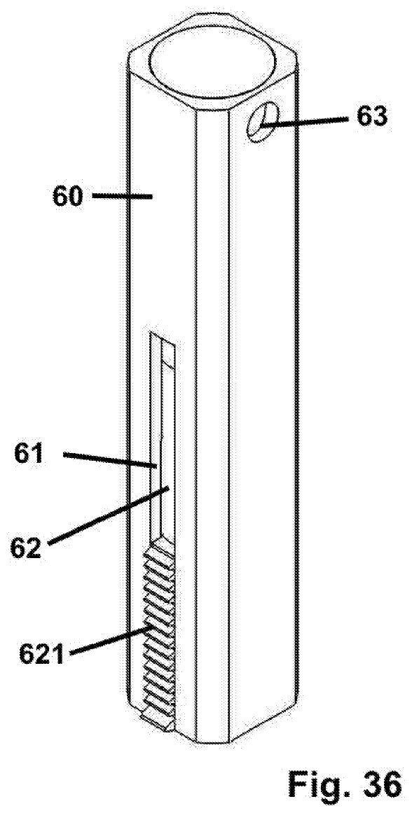

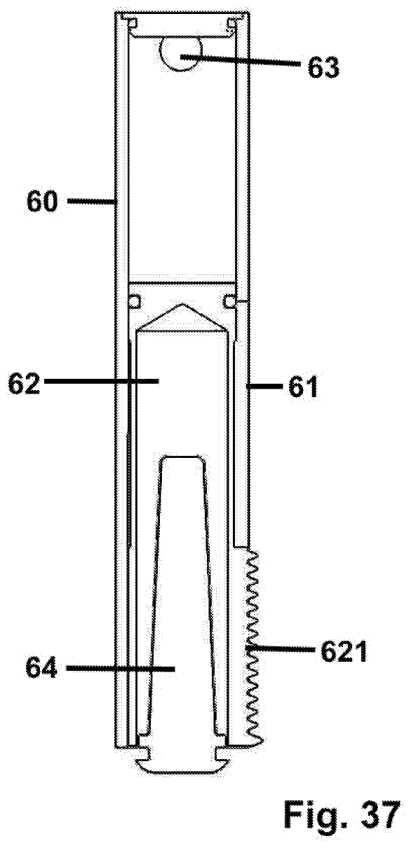

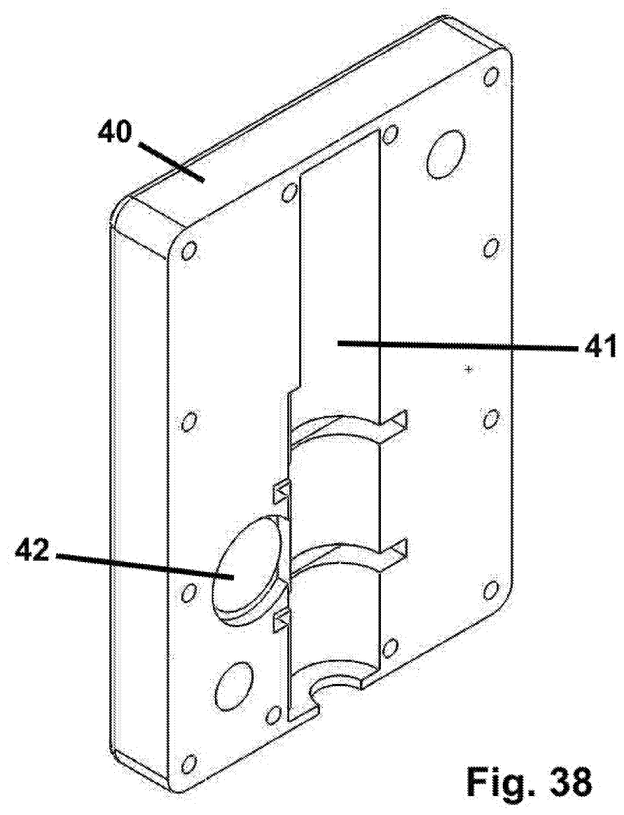

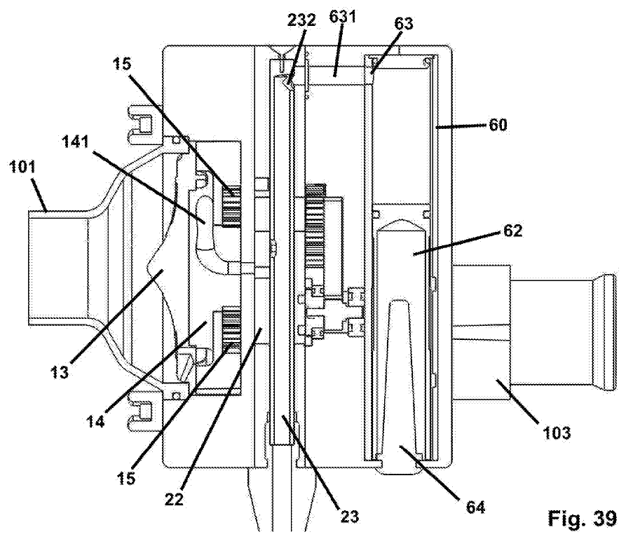

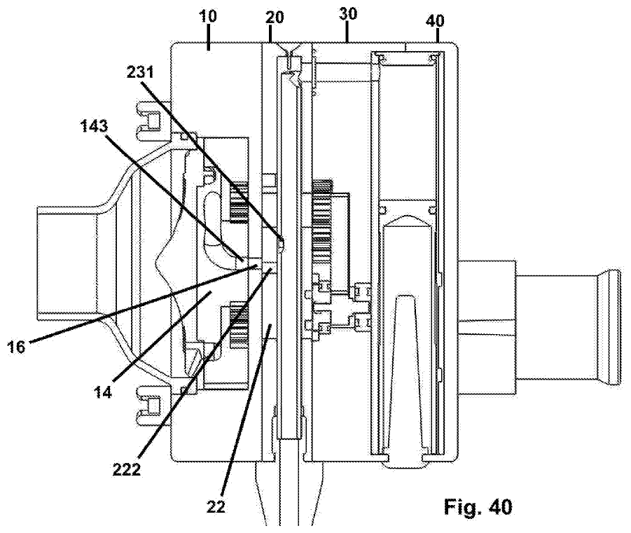

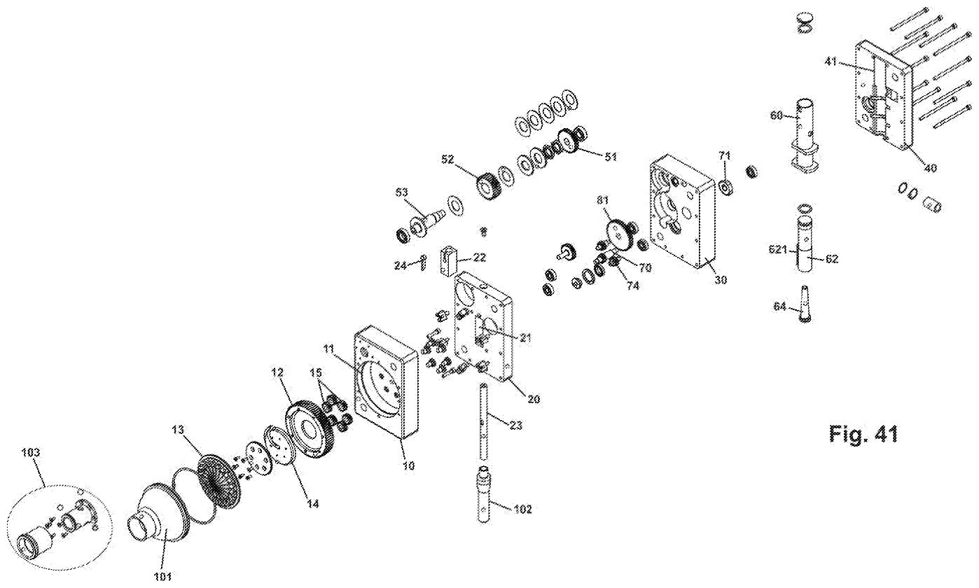

The pressurizer system (60) is provided with a groove (61) internally having a piston (62) provided with a rack (621) that, when it engages in the semi-gear (71) loads a spring (64) and when it enters the sector with no teeth, releases the spring to drive the piston (62), creating a pulsating air pressure directed through the hole (63) to the tube (23) through internal channeling (631), as described in FIGS. 35, 36 and 37.

The structure (40) has a bass-relief (41) which receives half cylinder of the pressurizer (60), the other half being arranged with the structure (30). The structure (40) works as the equipment's back lid so that in this function the structure will have the drilling for installing the equipment in the planting line hole and drilling (42) which will receive the equipment traction fixing housing (103).

Therefore, the seeding positioner device applied to agricultural planters has its operation through escutcheon (101) which directs the seeds over the seed selection cone (13) and labyrinth (14). The cone (13) is attached to the geared plate (12) in order to follow the rotation movement, while the labyrinth (14) rotates in the opposite direction due to the drive system of the planetary gears (15), allowing the seed to selected through the cone (13) to be captured by the groove (141) of the labyrinth (14) in order to position and direct the seeds in line to the compartment (22).

When the compartment (22) is at the top, it aligns the central hole (143) of the labyrinth (14) with the hole (222) of the same size housing the seed in its inner part, then leading to the low (or high) part of the course, wherein it aligns the hole (222) of the compartment (22) with the side hole (231) of the discharge tube (23). At this moment the seed, with a pulsating air flow synchronized with the movement of the compartment (22) directs the seed to the discharge nozzle (102) with a speed higher than that generated by gravity, sinking the seed into the soil groove, with no damage to the seed coat. This avoids the “chopping” or “rolling” of the seed, which changes the spacing between grains, decreasing productivity.

Optionally, the equipment can be driven by an electric motor, a pneumatic motor, a hydraulic motor, a cardan shaft, a pitch chain, or a twisting cable, depending on the planter type.

Optionally, the device will be applied and adapted to work with any seed type.

Optionally, the replacement of the friction clutch system (50) with the use of an electric drive and control motor.

Thus, it is the object of the present invention a seeding positioner device applied to agricultural planters comprising a structure consisted of a rotating seed pusher (13) that directs the seeds to a labyrinth (14) moving in the opposite direction, allowing to control the seed release according to the speed at which the assembly rotates so that the discharge spacing will be controlled by a compartment (22) driven by gears directing the seeds to a discharge tube (23), wherein a pneumatic system (60) generates positive air pressure. Thus, the compressed air will push the seed against the soil in order to maintain the perfect line positioning and increasing the planting speed. In addition, the device can be applied and adapted to work with any seed type, increasing the planting speed in order to avoid the incidence of double seeds and mechanical damage to the seeds.

1. A seeding positioner device applied to agricultural planters comprising a structure (100) provided with a escutcheon (101) for attaching the seed tube, a discharge nozzle (102) next to the soil and an equipment traction coupling system (103), the structure (100) being consisted of an assembly of structures (10), (20), (30) and (40) allowing the positioning of its components; the structure (10) having a circular bass-relief (11) receives the arrangement of a geared plate (12) having a bass-relief (121) in its front portion provided with a through hole (122) and it has in its back portion a bass-relief (123) provided with teeth (124), said geared plate (12) having protrusions (125) arranged at the front face which allow fitting and attachment with the seed cone (13); the seed selection cone (13) having an assembly of holes (131) aligned with grooves (132) so that the cone has a high relief (133) in its central portion, fins (134) arranged at the lower portion with the holes (131) and spacings (135) receiving the protrusions (125) from gear (12); a labyrinth (14) provided with a groove (141) having a winding shape from the edge to the central portion and a gear (142) provided with hole (143) connected to an assembly of planetary gears (15) fixed at the structure (10); the structure (10) has a circular spacing (17) arranged next to the upper portion receiving the assembly of gear (50) moving together with the geared plate (12) in order to compensate for a possible lack of seed with one or more holes (131) of the cone (13); this embodiment allows for labyrinth (14) to perform the rotational movement in opposite direction to the plate (12) in order to force the entry of seeds to the groove (141), directing the seeds through the hole (143) to the central point (16) positioning the seed with the structure (20) having discharge spacing; the structure (20) describes a central opening (21) provided with a compartment (22) having a discharge tube (23) connected to nozzle (102) of the equipment (100), said compartment (22) having a transversal hole (221) receiving the discharge tube (23) and a longitudinal hole (222), being the hole (222) connected to the upper portion of the hole (221) through a groove (223) and at the back portion of the compartment (22) is arranged an oblong hole (224), said central opening (21) having a structure (24) that fits with the groove (223) from the compartment (22) in order to help the vertical movement and direction of the seed to the hole (231); the cylindrical-shaped tube (23) is provided with a hole (231) allowing for alignment with the hole (222) of the compartment (22) and hole (232) enabling an entry, allowing on each vertical movement from the compartment (22) the seed is directed to the hole (231) of the tube (23) and forwarded to the nozzle (102) of the equipment; the drive system of gear assembly is performed by motor energy (not shown) which conveys the rotational movement to the shaft (70) provided with a semi-gear (71) driving the pressurizer system (60) and an intermediate gear (72) moving the shaft (80) provided with a main gear (81) and intermediate gear (82); the pressurizer system (60) is provided with a groove (61) internally having a piston (62) provided with a rack (621) which when engaged at semi-gear (71) loads a spring (64) and when it enters the no teeth sector, it releases the spring to drive the piston (62), creating a pulsing air pressure directed by the hole (63) to the tube (23) through internal channeling (631); the structure (40) has a bass-relief (41) receiving half of the pressurizer cylinder (60), being the other half arranged with the structure (30), said structure (40) acting as an equipment back lid such as at this function the structure will have drillings for installing the equipment at the planting line hole and a drilling (42) receiving the equipment traction fixing housing (103).

2. The seeding positioner device applied to agricultural planters, according to claim 1, wherein the cone (13) has a shape enabling the seeds to be selected and positioned on the assembly of holes (131) being the high relief (133) aligned with the escutcheon (101).

3. The seeding positioner device applied to agricultural planters, according to claim 1, wherein the cone (13) has fins (134) arranged in the lower portion with the holes (131) so as to facilitate the seed direction.

4. The seeding positioner device applied to agricultural planters, according to claim 1, wherein the cone (13) is fixed with the geared plate (12) through spacings (135) receiving the protrusions (125) of gear (12) so as to follow its rotational movement, allowing the selector (13) supportive rotates with the annular gear (12).

5. The seeding positioner device applied to agricultural planters, according to claim 1, wherein the labyrinth (14) enables the seed arranged in the cone (13) is captured by the labyrinth (14) and positioned with the central point (16) of the structure (10).

6. The seeding positioner device applied to agricultural planters, according to claim 1, wherein the labyrinth (14) is arranged with the bass-relief (121) so as the gear (142) is positioned with the hole (122) of the geared plate (12).

7. The seeding positioner device applied to agricultural planters, according to claim 1, wherein the geared plate (12) allows for the movement of cone (13) and labyrinth (14) is performed in the opposite direction.

8. The seeding positioner device applied to agricultural planters, according to claim 1, wherein the external gearing of geared plate (12) makes the connection of clutch gear (50), which brings external force to the annular gear (12) making the gear (12) rotate in one direction.

9. The seeding positioner device applied to agricultural planters, according to claim 1, wherein the internal gearing moves the planetary gears (15) which brings movement to the solar gear (142) of the labyrinth (14) in the opposite direction of the annular gear (12), said solar gear (142) being rigidly attached to the labyrinth (14).

10. The seeding positioner device applied to agricultural planters, according to claim 1, wherein the cone (13) and labyrinth (14) have the function of neatly convey the seeds to the groove (141) from the labyrinth (14) so as the seeds fall through hole central (143) into compartment (22) which will define the release of seeds/minute to the discharge tube (102).

11. The seeding positioner device applied to agricultural planters, according to claim 1, wherein the compartment (22) is aligned with the hole (143) from the labyrinth (14) so as the seed is directed into the compartment (22), thus the compartment is moved vertically until the seed is directed to the hole (231) of the tube (23) by aid of the structure (24).

12. The seeding positioner device applied to agricultural planters, according to claim 1, wherein the structure (20) has in its back portion a spacing (25) aligned with the hole (232) of tube (23) allowing the air to be directed into the tube.

13. The seeding positioner device applied to agricultural planters, according to claim 1, wherein the gear (81) conveys its rotation to the shaft (73) by moving an intermediate gear (74), said shaft (73) having in its end a cam pin that fits the compartment (22) through the oblong hole (224), causing the compartment (22) to have a rectilinear and alternative movement (up and down).

14. The seeding positioner device applied to agricultural planters, according to claim 1, wherein the intermediate gear (82) conveys the movement to a pair of intermediate gears (83) conveying the energy to the gear (51) from clutch system (50), moving the geared plate (12) and cone (13) e labyrinth (14) system.

15. The seeding positioner device applied to agricultural planters, according to claim 1, wherein the clutch system (50) ensures that above a certain torque the gear (52) arranged with the geared plate (12) slides on the shaft (53), unplugging the power source of the consuming assembly.

16. The seeding positioner device applied to agricultural planters, according to claim 1, wherein optionally the equipment is driven by an electric motor, a pneumatic motor, a hydraulic motor, a cardan shaft, a pitch chain, or a twisting cable, according to the planter type.

17. The seeding positioner device applied to agricultural planters, according to claim 1, wherein optionally the friction clutch system (50) is replaced with an electric motor.
